(19) United States
(12) Patent Application Publication
(10) Pub. No.: US 2023/0162595 A1
(43) Pub. Date: May 25, 2023

(54) V2X ROUTE CONFLICT WITH EMERGENCY VEHICLE INDICATOR

(71) Applicant: GM Global Technology Operations LLC, Detroit, MI (US)

(72) Inventors: Thomas A. Seder, Fraser, MI (US); Kai-Han Chang, Madison Heights, MI (US)

(21) Appl. No.: 17/534,982

(22) Filed: Nov. 24, 2021

(51) Int. Cl. G08G 1/01; G06F 3/14; H04W 4/40; G08G 1/052; G08G 1/056; G08G 1/0962; G08G 1/0968; G08G 1/0969; G08G 1/087; G01C 21/36; G01C 21/34

(52) U.S. Cl. CPC G08G 1/0104; G06F 3/14; H04W 4/40; G08G 1/052; G08G 1/056; G08G 1/09626; G08G 1/096855; G08G 1/0969; G08G 1/087; G01C 21/365; G01C 21/3415

(57) ABSTRACT

A route conflict with emergency vehicle identification system includes an infrastructure receiving vehicle location, speed and trajectory information of an emergency vehicle. An automobile vehicle is in communication with the infrastructure and receives the vehicle location, speed and trajectory information of the emergency vehicle. A navigation system of the automobile vehicle operates using global positioning system (GPS) data and preloaded map data to generate a map identifying at least one roadway and a potential conflict on the at least one roadway between projected paths of the emergency vehicle and the automobile vehicle on the at least one roadway. A head-up display or a head-down display of the automobile vehicle visually presents the potential conflict.

### INTRODUCTION

The present disclosure relates to identifying and locating emergency vehicles on highways and roadways.

The rate of emergency vehicle collisions during a light and sirens-on response is approximately 16.7 per 100,000 emergency vehicle operations. Ambulances are involved in 6000 accidents per year with approximately 35% of the accidents involving a fatality. These statistics are overwhelmingly due to a lack of awareness of the presence of emergency vehicles by other drivers. Even if a siren is detected, it may be difficult by the operator of another vehicle to locate the origin of the sound and assess the proximity and position of an emergency vehicle.

Even an aware operator may have difficulty locating an emergency vehicle even if sirens are sounding and emergency lights are flashing. This may be due to a difficulty of determining the direction of sound origin when the operator is in an enclosed vehicle with the windows closed, and this situation is enhanced for operators who may be hearing impaired. Flashing lights of an emergency vehicle in cross traffic may also be out of sight of the vehicle operator or hidden by other vehicles or roadway objects.

Thus, while current vehicle global positioning systems achieve their intended purpose, there is a need for a new and improved route conflict with emergency vehicle identification system.

### SUMMARY

According to several aspects, a route conflict with emergency vehicle identification system includes an infrastructure receiving vehicle location, speed and trajectory information of an emergency vehicle. An automobile vehicle is in communication with the infrastructure and receives the vehicle location, speed and trajectory information of the emergency vehicle. A navigation system of the automobile vehicle operates using global positioning system (GPS) data and preloaded map data to generate a map identifying at least one roadway and a potential conflict on the at least one roadway between projected paths of the emergency vehicle and the automobile vehicle on the at least one roadway. A head-up display or a head-down display of the automobile vehicle visually presents the potential conflict.

In another aspect of the present disclosure, the potential conflict defines a trajectory conflict zone superimposed onto the map generated by the vehicle navigation system.

In another aspect of the present disclosure, the trajectory conflict zone includes a total length allowing for a time difference for the emergency vehicle and the automobile vehicle to reach a common location.

In another aspect of the present disclosure, a first end of the trajectory conflict zone defines an earliest projected time for the emergency vehicle to reach the common location, and a second end of the trajectory conflict zone defines a latest projected time for the emergency vehicle to reach the common location.

In another aspect of the present disclosure, at least one data window of the head-up display or the head-down display is provided, onto which is streamed an information display providing a digital speed display and a heading of the automobile vehicle.

In another aspect of the present disclosure, when generated the trajectory conflict zone is visually presented by the head-up display or the head-down display onto an impacted zone or area of the at least one roadway to alert an operator of the automobile vehicle of a potential travel path conflict.

In another aspect of the present disclosure, a first emergency vehicle symbol and an alert message presented by an information display of the head-up display or the head-down display identify the emergency vehicle may be traveling into the trajectory conflict zone.

In another aspect of the present disclosure, the at least one roadway includes a first roadway having the emergency vehicle traveling thereon and a second roadway having the automobile vehicle traveling thereon, and wherein the trajectory conflict zone is superimposed onto an intersection between the first roadway and the second roadway.

In another aspect of the present disclosure, a projected interference portion of the at least one roadway defines a closed road portion generated and presented by the head-up display or the head-down display which defines a lane portion of the at least one roadway where the emergency vehicle may be present.

In another aspect of the present disclosure, a recommended stop instruction is generated by the navigation system for the automobile vehicle including “stop to right” or “stop to left”, the recommended stop instruction presented on the head-up display or the head-down display.

According to several aspects, a route conflict with emergency vehicle identification system includes a position of an emergency vehicle transponded to an infrastructure using V2X. An emergency vehicle trajectory data is relayed from the infrastructure to an automobile vehicle proximate to the emergency vehicle. A navigation system of the automobile vehicle is utilized to probe for conflicts in trajectories of the emergency vehicle and the automobile vehicle. A roadway is reserved for the emergency vehicle highlighted in an image plane of a head-up display or a head-down display of the automobile vehicle. Emergency vehicle information is presented on an augmented reality plane of the head-up display when a conflict between a first travel path of the emergency vehicle and a second travel path of the automobile vehicle is detected.

In another aspect of the present disclosure, the emergency vehicle information further includes the number of emergency vehicles in conflict.

In another aspect of the present disclosure, the emergency vehicle information further includes directions to the emergency vehicle including left or right in an intersection of the roadway.

In another aspect of the present disclosure, the emergency vehicle information further includes a relative direction of the emergency vehicle such as being straight behind or straight ahead of the automobile vehicle.

In another aspect of the present disclosure, the head-up display or the head-down display functions to highlight threats including other vehicles that are in a path of the automobile vehicle and visible to an operator of the automobile vehicle thereby enhancing threat conspicuity and detection.

In another aspect of the present disclosure, a projected interference portion is projected by the head-up display or the head-down display onto a current travel lane of the roadway presently being driven by the automobile vehicle defining a path available for travel of the emergency vehicle.

In another aspect of the present disclosure, a projected interference portion is projected by the head-up display or the head-down display onto an oncoming lane of the roadway defining a path available for travel of the emergency vehicle in a direction opposite to a direction of current travel of automobile vehicle.

According to several aspects, a method for identifying emergency vehicles and resolving vehicle to vehicle conflicts includes: transponding a position of an emergency vehicle to an infrastructure using V2X; relaying emergency vehicle trajectory data from the infrastructure to an automobile vehicle proximate to the emergency vehicle; utilizing a navigation system of the automobile vehicle to probe for conflicts in trajectories of the emergency vehicle and the automobile vehicle; highlighting a roadway reserved for the emergency vehicle in an image plane of a head-up display or a head-down display of the automobile vehicle; and presenting emergency vehicle information on an augmented reality plane of the head-up display or the head-down display when a conflict is detected.

In another aspect of the present disclosure, the method further includes reserving travel lanes for the emergency vehicle and controlling traffic lights to provide all green lights to the emergency vehicle on the roadway.

In another aspect of the present disclosure, the method further includes utilizing a navigation system of the automobile vehicle operating using global positioning system (GPS) data and preloaded map data and generating a map identifying the roadway and a potential conflict on the roadway between projected paths of the emergency vehicle and the automobile vehicle on the roadway.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side elevational view of a route conflict with emergency vehicle identification system according to an exemplary aspect;

FIG. 2 is an end view looking forward from an automobile using the system of FIG. 2;

FIG. 3 is a diagrammatic presentation of a map produced using the system of FIG. 1;

FIG. 4 is an end view modified from FIG. 2 to present conflict resolution results;

FIG. 5 is a diagrammatic presentation of the map of FIG. 3 further showing a superimposed trajectory conflict zone;

FIG. 6 is an end view looking forward modified from FIG. 2 to further present multiple emergency vehicle information and a forward directed projected interference portion of the upcoming roadway; and

FIG. 7 is an end view looking forward modified from FIG. 6 to present multiple emergency vehicle information and to further present a rearward directed projected interference portion of the upcoming roadway.

### DETAILED DESCRIPTION

The following description is merely exemplary in nature and is not intended to limit the present disclosure, application, or uses.

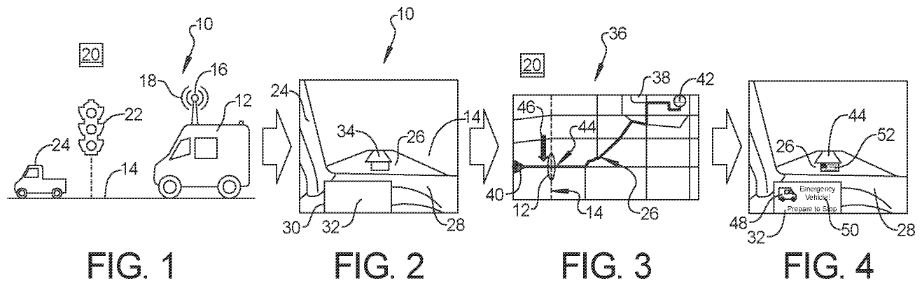

Referring to FIG. 1, a route conflict with emergency vehicle identification system 10 is initiated to identify a presence of an emergency vehicle 12 traveling on a first roadway 14. The emergency vehicle 12 may be an ambulance, a police vehicle, a fire truck, and the like. The emergency vehicle 12 transmits vehicle location, speed and trajectory information using a transmission system 16 which generates electronic signal data 18 representing the vehicle location, speed and trajectory information which is received and disseminated by an infrastructure 20 such as a cloud data system. A common form of data management used by the infrastructure 20 includes a V2X system portion. A V2X system refers to ‘Vehicle-to-Everything,’ or ‘vehicle to X,’ and operates by passing information from any vehicle to any entity that may affect the vehicle and vice versa.

The information travels from sensors in the vehicle such as the emergency vehicle 12 and other sources through high-bandwidth, high-reliability links, allowing communication with other vehicles, infrastructure such as parking spaces and traffic lights 22 such as a stoplight or pedestrian crossing light. For example, by sharing information of the emergency vehicle 12 such as speed, direction of travel and type of vehicle with other entities around the emergency vehicle 12, the awareness of an operator of an automobile vehicle 24 positioned in proximity to the emergency vehicle 12 of potential dangers and interactions with a path of travel of the emergency vehicle 12 helps reduce a likelihood of collision between the emergency vehicle 12 and the automobile vehicle 24, reduction of severity of injuries, and reduction of road accident fatalities.

Referring to FIG. 2 and again to FIG. 1, the route conflict with emergency vehicle identification system 10 may operate in conjunction with the automobile vehicle 24 defining a host vehicle which is traveling on a second roadway 26 or may be traveling on the same first roadway 14 as the emergency vehicle 12. The automobile vehicle 24 includes an augmented reality (AR) head-up display (HUD) 28 which generates and presents data to an operator of the automobile vehicle 24 on at least one data window 30 onto which is streamed an information display 32, which may for example provide a digital speed display and a heading 34 of the automobile vehicle 24. According to several aspects, the head-up display (HUD) 28 may also be replaced by a head-down display within the scope of the present disclosure. Further discussion of the head-up display (HUD) 28 herein may therefore equally include the head-down display.

Referring to FIG. 3 and again to FIGS. 1 and 2, a vehicle navigation system 36 of the automobile vehicle 24 operates for example using global positioning system (GPS) data and preloaded map data to create a map 38 which identifies for example the first roadway 14 and the second roadway 26. An automobile vehicle symbol 40 represents the automobile vehicle 24 traveling on the second roadway 26 toward a trip end point 42. Using data received from the infrastructure 20 the vehicle navigation system 36 probes for any conflicts in the travel paths of the automobile vehicle 24 and the emergency vehicle 12 and calculates and presents a trajectory conflict zone 44 defining a potential collision between the emergency vehicle 12 and the automobile vehicle 24 as the emergency vehicle 12 travels in a direction of travel 46 toward the emergency vehicle 12 or toward an intersection of the first roadway 14 and the second roadway 26.

Referring to FIG. 4, when generated the trajectory conflict zone is visually presented by the HUD 28 onto the impacted zone or area of the first roadway 14 or the second roadway 26 to alert the operator of the automobile vehicle 24 of the potential travel path conflict. At this time, the information display 32 presents a first emergency vehicle symbol 48 and an alert message 50 identifying an emergency vehicle has been identified which may be traveling into the trajectory conflict zone 44. A second emergency vehicle symbol 52 may also be projected by the HUD 28 onto the vehicle travel path of the second roadway 26 ahead of the visually presented trajectory conflict zone 44 to further notify the operator of the automobile vehicle 24.

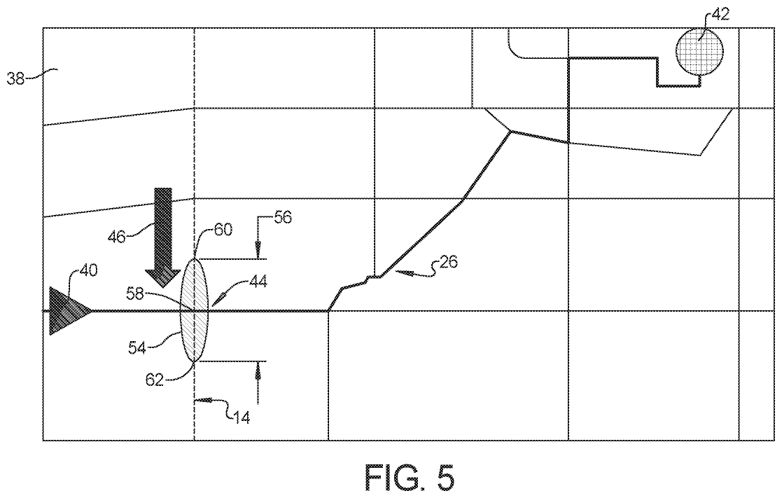

Referring to FIG. 5 and again to FIG. 3, the trajectory conflict zone 44 is superimposed onto the map 38 generated by the vehicle navigation system and may have any desired geometric shape and is presented in an exemplary oval shape on FIGS. 3 and 5, having a total length 56. The total length 56 of the trajectory conflict zone 44 allows for a time difference for the emergency vehicle 12 and the automobile vehicle 24 to reach a common location such as an intersection 58 between the first roadway 14 and the second roadway 26. The total length 56 allows for potential changes in speed of the emergency vehicle 12 and of the automobile vehicle 24 as they progress toward the intersection 58. For example, a first end 60 of the trajectory conflict zone 44 defines an earliest projected time for the emergency vehicle 12 to reach the common location or intersection 58, and a second end 62 of the trajectory conflict zone 44 defines a latest projected time for the emergency vehicle 12 to reach the common location or intersection 58, after which a collision with the automobile vehicle 24 is least likely.

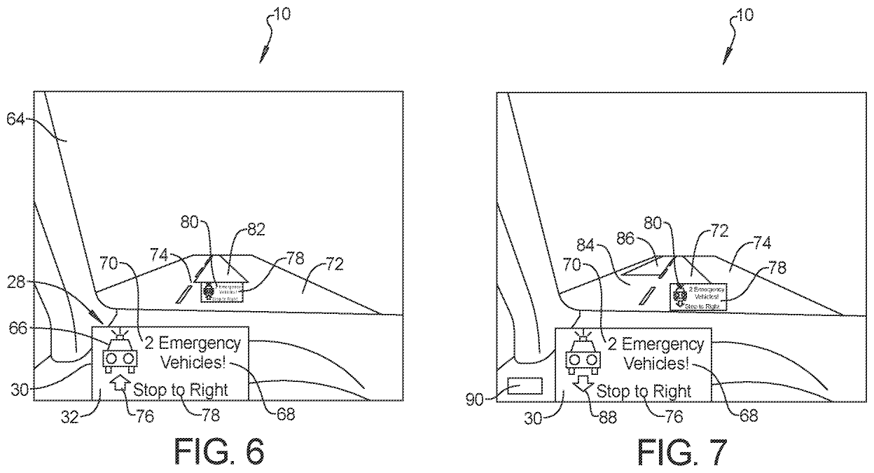

Referring to FIG. 6 and again to FIGS. 2 and 4, according to several aspects the route conflict with emergency vehicle identification system 10 may also receive data and provide analyses of potential conflicts between the host or automobile vehicle 24 and two or more emergency vehicles which may commonly include an ambulance and a fire truck or an ambulance and a police vehicle. In these scenarios, the emergency vehicle identification system 10 identifies a best-case position or zone for the automobile vehicle 24 to stop to avoid the one or more emergency vehicles. In the example provided in FIG. 6, an operator's view through a windshield 64 of the automobile vehicle 24 is presented. The information display 32 of the at least one data window 30 presents a third emergency vehicle symbol 66 and an alert message 68 which varies from the alert message 50 by identifying a quantity 70 of projected emergency vehicles, which in the example provided identifies two (2) emergency vehicles may be encountered on a current travel lane 72 of a third roadway 74 upon which the automobile vehicle 24 is traveling.

Because multiple emergency vehicles may be encountered, the route conflict with emergency vehicle identification system 10 identifies a best location for the automobile vehicle 24 to pull off the third roadway 74 to minimize potential conflicts with any of the emergency vehicles. Further operator assistance is provided by identifying a direction 76 with respect to the automobile vehicle 24 where an encounter with an emergency vehicle may occur, and identifies a recommended stop instruction 78 for the automobile vehicle 24, such as “stop to right”, “stop to left”, and the like. A fourth emergency vehicle symbol 80 is also projected by the HUD 28 onto the visually presented third roadway 74 which may be the same as or differ from the head-up display 28. A projected interference portion 82 of the upcoming third roadway 74 defining for example a closed road portion is generated and presented by the HUD 28 which presents a lane portion of the third roadway 74 where emergency vehicles may be present.

Referring to FIG. 7 and again to FIGS. 2, 4 and 6, according to other aspects the route conflict with emergency vehicle identification system 10 identifies when one or more emergency vehicles may be present in a second lane or an oncoming lane 84 of the third roadway 74 which are different than the current travel lane 72 of the automobile vehicle 24. A second projected interference portion 86 is projected by the head-up display 28 onto the oncoming lane 84 which is similar in appearance but opposite lane located with respect to the projected interference portion 82 described in reference to FIG. 6. The fourth emergency vehicle symbol 80 may be projected by the HUD 28 onto the visually presented current travel lane 72 which may be the same as or differ from the HUD 28. Further operator assistance is provided by identifying a direction 88 with respect to the automobile vehicle 24 opposite to the direction 76 described in reference to FIG. 6 where the one or more emergency vehicles may be traveling, and identifies the recommended stop instruction 78, such as “stop to right”, “stop to left”, and the like. The fourth emergency vehicle symbol 80 is also projected by the HUD 28 onto the visually presented third roadway 74 which may be the same as or differ from the display described in reference to FIGS. 4 and 6.

According to several aspects, a haptic seat device 90 of the automobile vehicle 24 reinforces directional information via right-left-fore-aft actuator engagement to the operator of the automobile vehicle 24. Actuation of the haptic seat device 90 signifies to the operator a relative direction of potential conflicts due to the emergency vehicle 12 or the multiple emergency vehicles.

An exemplary use case for the augmented reality HUD 28 is to highlight imminent threats on the roadway ahead. Threats may be threats that are currently physically present or threats that will appear due to conflict of the vehicle's trajectory and that of the threat. The route conflict with emergency vehicle identification system 10 of the present disclosure probes for imminent collision threats with emergency vehicles using V2X data and highlights the roadway where a collision may occur unless the conflict is resolved. The system of the present disclosure also generates conflict resolution recommendations such as recommending a vehicle stop direction or location.

The route conflict with emergency vehicle identification system 10 of the present disclosure may use augmented reality HUDs for situations including to highlight threats such as other vehicles that are in a path of the automobile vehicle and visible to an operator of the automobile vehicle thereby enhancing threat conspicuity and detection. One or more areas of the roadway where an imminent collision is predicted with emergency vehicles that are not visible to the driver are highlighted. The present system probes for imminent collision threats with emergency vehicles using V2X data and highlights using the HUD 28 the roadway where a collision may occur unless the conflict is resolved.

A route conflict with emergency vehicle identification system 10 of the present disclosure offers several advantages. These include emergency vehicle situation awareness and conflict resolution that includes the following features: 1) Emergency vehicles transpond their position and intent to an infrastructure such as using V2X. 2) The infrastructure relays emergency vehicle trajectory data to all surrounding vehicles and reserves travel lanes for the emergency vehicle. This may include controlling traffic lights such as providing all green lights to the emergency vehicle. 3) A navigation system of the automobile vehicle probes for conflict in the trajectories of the emergency vehicle and the automobile vehicle. 4) The system highlights the roadway reserved for the emergency vehicle in a second image plane of a dual plane head-up-display (HUD). An augmented reality plane of the HUD, when a conflict is detected, presents emergency vehicle information, with priority given in a near image plane. This information may include but is not limited to a number of emergency vehicles in conflict, a relative direction of the emergency vehicles such as being straight behind or straight ahead of the object or the automobile vehicle, and directions such as left or right in an intersection. 5) A haptic seat device of the automobile vehicle reinforces directional information via right-left-fore-aft actuator engagement.

If a number greater than one of emergency vehicles are projected to be in conflict with a path of the automobile automobile vehicle 24, a relative direction of the multiple emergency vehicles 12 (straight behind or straight-ahead, left or right in an intersection) is projected.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A route conflict with emergency vehicle identification system, comprising:
an infrastructure receiving a vehicle location, a vehicle speed and a vehicle trajectory information of an emergency vehicle;
an automobile vehicle in communication with the infrastructure and receiving the vehicle location, the vehicle speed and the vehicle trajectory information of the emergency vehicle;
a navigation system of the automobile vehicle operating using a global positioning system (GPS) data and a preloaded map data to generate a map including at least one roadway and a potential conflict on the at least one roadway between projected paths of the emergency vehicle and the automobile vehicle on the at least one roadway; and
a head-up display or a head-down display of the automobile vehicle visually presenting the potential conflict.

2. The system of claim 1, wherein the potential conflict defines a trajectory conflict zone superimposed onto the map generated by the navigation system.

3. The system of claim 2, wherein the trajectory conflict zone includes a total length defining a time difference for the emergency vehicle and the automobile vehicle to reach a common location.

4. The system of claim 3, wherein a first end of the trajectory conflict zone defines an earliest projected time for the emergency vehicle to reach the common location, and a second end of the trajectory conflict zone defines a latest projected time for the emergency vehicle to reach the common location.

5. The system of claim 1, further including at least one data window of the head-up display or the head-down display onto which is streamed an information display providing a digital speed display and a heading of the automobile vehicle.

6. The system of claim 2, wherein when generated the trajectory conflict zone is visually presented by the head-up display or the head-down display onto an impacted zone or area of the at least one roadway to alert an operator of the automobile vehicle of a potential travel path conflict.

7. The system of claim 6, further including a first emergency vehicle symbol and an alert message presented by an information display of the head-up display or the head-down display identifying the emergency vehicle may be traveling into the trajectory conflict zone.

8. The system of claim 2, wherein the at least one roadway includes a first roadway having the emergency vehicle traveling thereon and a second roadway having the automobile vehicle traveling thereon, and wherein the trajectory conflict zone is superimposed onto an intersection between the first roadway and the second roadway.

9. The system of claim 1, further including a projected interference portion of the at least one roadway defining a closed road portion generated and presented by the head-up display or the head-down display which defines a lane portion of the at least one roadway where the emergency vehicle may be present.

10. The system of claim 1, further including a recommended stop instruction generated by the navigation system for the automobile vehicle, the recommended stop instruction including “stop to right” or “stop to left”, wherein the recommended stop instruction is presented on the head-up display or the head-down display.

11. A route conflict with emergency vehicle identification system, comprising:
a position of at least one emergency vehicle transponded to an infrastructure including a V2X infrastructure portion;
an emergency vehicle trajectory data relayed from the infrastructure to an automobile vehicle located proximate to the emergency vehicle;
a navigation system of the automobile vehicle utilized to probe for conflicts in trajectories of the at least one emergency vehicle and the automobile vehicle;
a head-up display or a head-down display of the automobile vehicle;
a roadway reserved for the at least one emergency vehicle highlighted in an image plane of the head-up display or the head-down display; and
emergency vehicle information presented on an augmented reality plane of the head-up display or the head-down display when a conflict between a travel path of the at least one emergency vehicle and a second travel path of the automobile vehicle is detected.

12. The system of claim 11, wherein the at least one emergency vehicle defines multiple emergency vehicles, and wherein the emergency vehicle information further includes a quantity of the multiple emergency vehicles in conflict.

13. The system of claim 11, wherein the emergency vehicle information further includes directions to the at least one emergency vehicle including left or right in an intersection of the roadway.

14. The system of claim 11, wherein the emergency vehicle information further includes a relative direction of the at least one emergency vehicle such as being straight behind or straight ahead of the automobile vehicle.

15. The system of claim 11, wherein the head-up display or the head-down display includes a highlight function identifying threats including other vehicles that are in a path of the automobile vehicle and visible to an operator of the automobile vehicle thereby enhancing threat conspicuity and detection.

16. The system of claim 11, wherein a projected interference portion is projected by the head-up display onto a current travel lane of the roadway presently being driven by the automobile vehicle defining a path available for travel of the emergency vehicle.

17. The system of claim 11, wherein a projected interference portion is projected by the head-up display or the head-down display onto an oncoming lane of the roadway defining a path available for travel of the emergency vehicle in a direction opposite to a direction of current travel of automobile vehicle.

18. A method for identifying vehicles and resolving vehicle to vehicle conflicts, comprising:
transponding a position of an emergency vehicle to an infrastructure having a V2X infrastructure portion;
relaying emergency vehicle trajectory data from the infrastructure to an automobile vehicle located proximate to the emergency vehicle;
operating a navigation system of the automobile vehicle to probe for conflicts in trajectories of the emergency vehicle and the automobile vehicle;
highlighting a roadway reserved for the emergency vehicle in an image plane of a head-up display or a head-down display of the automobile vehicle; and
presenting emergency vehicle information on an augmented reality plane of the head-up display or the head-down display when a conflict is detected.

19. The method of claim 18, further including reserving travel lanes for the emergency vehicle and controlling traffic lights to provide all green lights to the emergency vehicle on the roadway.

20. The method of claim 18, further including utilizing a navigation system of the automobile vehicle operating using global positioning system (GPS) data and preloaded map data and generating a map identifying the roadway and a potential conflict on the roadway between projected paths of the emergency vehicle and the automobile vehicle on the roadway.
